(19) United States
(12) Patent Application Publication
(10) Pub. No.: US 2025/0084989 A1
(43) Pub. Date: Mar. 13, 2025

(54) Light Up Backpack Device

(71) Applicant: Michael Ryan, Winter Haven, FL (US)

(72) Inventor: Michael Ryan, Winter Haven, FL (US)

(21) Appl. No.: 18/657,060

(22) Filed: May 7, 2024

Related U.S. Application Data
(60) Provisional application No. 63/581,777, filed on Sep. 11, 2023.

(51) Int. Cl. F21V 33/00; A45F 3/00; A45F 3/04; F21L 4/02; F21V 23/00; F21V 23/04; F21Y 113/00; F21Y 115/10

(52) U.S. Cl. CPC F21V 33/0004; A45F 3/04; F21L 4/02; F21V 23/003; F21V 23/0435; A45F 2003/003; F21Y 2113/00; F21Y 2115/10

(57) ABSTRACT

A light up backpack device is disclosed for easily identifying the user and improving their safety. The light up backpack device comprises a body component that is configured in a conventional backpack shape with a plurality of LEDs secured to an exterior surface. The plurality of LEDs are controlled with a Bluetooth remote control and can change colors and the pulse of the LEDs. The light up backpack device helps keep the user safe by illuminating them on the side of the road when waiting for a school bus or other ride. The device may also be made for others to improve their safety, such as hikers and motorcyclists, etc.

### CROSS-REFERENCE TO RELATED APPLICATION

The present application claims priority to, and the benefit of, U.S. Provisional Application No. 63/581,777, which was filed on Sep. 11, 2023, and is incorporated herein by reference in its entirety.

### FIELD OF THE INVENTION

The present invention relates generally to the field of light up backpack devices. More specifically, the present invention relates to a backpack featuring multiple exterior LED lights for easily identifying the user. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in light up backpack devices. Generally, children getting picked up by their parents or a school bus during early morning or nighttime hours may not be fully visible if they are waiting by the side of the road. Additionally, the child may also not be easily seen by approaching vehicles and serious accidents could occur. Further, children may enjoy decorating their backpacks with different lights and accessories.

Pedestrian safety is becoming more and more important in urban areas. Not only is it important for a person on foot to be noticeable to drivers after dark, but it is equally important that they draw attention to themselves during the daytime if traveling in busy urban areas with heavy traffic. This is especially important when it comes to children traveling as the sun begins to set or adults exercising after dark. Furthermore, backpacks are generally bags with shoulder straps that allow the bag to be carried on one's back, freeing up one's hands. They are often used to travel or hike while carrying one's belongings therein. Most often, backpacks are used by hikers and students. Therefore, there exists a need for a backpack that includes a lighting assembly that illuminates the users, easily identifying them during use.

Accordingly, there is a demand for an improved light up backpack device that features multiple exterior LED lights for easily identifying the user, even in low-light conditions. More particularly, there is a demand for a light up backpack device that allows children to wear the backpack and maintain safety when waiting for a school bus near the side of the road.

Therefore, there exists a long-felt need in the art for a light up backpack device that provides users with a backpack featuring multiple exterior LED lights for easily identifying the user. There is also a long-felt need in the art for a light up backpack device that allows children to wear the backpack and maintain safety when waiting for a school bus near the side of the road during early morning or evening hours. Further, there is a long-felt need in the art for a light up backpack device that brightly illuminates in one or several colors to improve visibility of the user while adding a fun and unique flair to the backpack. Moreover, there is a long-felt need in the art for a device that includes a remote control that can alter the colors and pulse frequency of the lights. Further, there is a long-felt need in the art for a light up backpack device that comprises multiple selections that can be made to adjust the lights and customize their illumination patterns, colors, and frequency. Finally, there is a long-felt need in the art for a light up backpack device that can be used by hikers or motorcycle riders, as well.

The subject matter disclosed and claimed herein, in one embodiment thereof, comprises a light up backpack device. The device is a backpack with added exterior LED lighting for the purpose of easily identifying the user and improving their safety. The light up backpack device comprises a body component that is configured in a conventional backpack shape with a plurality of LEDs secured to an exterior surface of the body component. The plurality of LEDs are controlled with a Bluetooth remote control and can change colors and the pulse of the LEDs. Multiple selections can be made to adjust the LEDs and customize their illumination patterns, colors, and frequency. The light up backpack device helps keep the user safe by illuminating them on the side of the road when waiting for a school bus or other ride. The device may also be made for others to improve their safety, such as hikers and motorcyclists, etc.

In this manner, the light up backpack device of the present invention accomplishes all of the foregoing objectives and provides users with a backpack device comprising a plurality of LEDs for safety. The device is a backpack with a plurality of LEDs on its exterior. The LEDs can be controlled by a remote control.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a light up backpack device. The device is a backpack with added exterior LED lighting for the purpose of easily identifying the user and improving their safety. The light up backpack device comprises a body component that is configured in a conventional backpack shape with a plurality of LEDs secured to an exterior surface of the body component. The light up backpack device helps keep the user safe by illuminating them on the side of the road when waiting for a school bus or other ride. The device may also be made for others to improve their safety, such as hikers and motorcyclists, etc.

In one embodiment, the light up backpack device comprises a body component configured as a conventional backpack. Specifically, the body component forms an interior volume therein. The body component includes an opening that provides access to the interior volume, wherein the opening includes a fastener that selectively opens and closes access to the interior volume. Preferably, the fastener is a zipper fastener, however, other suitable types of fasteners are contemplated. Preferably the body component is substantially rectangular in shape with a central apex, however, it is contemplated that the shape of the body component includes a variety of other shapes and forms. The body component further includes at least one strap attached thereon configured to be wrapped around a user's shoulder to support the backpack device. It is likewise contemplated that the straps can include a variety of other suitable types of straps such as long shoulder straps or cross body straps. Alternative embodiments also may include a second shoulder strap that allows a user to wear the backpack device around both shoulders.

In another embodiment, the body component is adapted to conveniently carry various personal effects in three separate partitioned compartments each accessible by a zippered fastener. Further, at the top of a back panel are fastened top ends of a pair of padded shoulder straps, the bottom ends of which are connected to adjusting straps fastened in turn to the bottom panel. Additionally, the backpack device is hand or machine-washable.

In one embodiment, the light up backpack device comprises a light component and a power pack component. The light component typically comprises a plurality of LEDs which are in communication with the power pack component. The power pack component comprises a microprocessor (or controller), at least one power source, a control switch, a transformer, a receiver, and at least one sensor, all for powering and controlling the LEDs. Further, at least one power source is typically a battery contained within a battery enclosure. In one embodiment, the battery is rechargeable. Then at least one battery provides the electricity needed to power the LEDs. Further, the power pack component, along with the battery, can be positioned inside the backpack device and communicates with the PCB (i.e., the plurality of LEDs) via wires or other connecting means.

In one embodiment, the power pack component comprises a transformer for voltage conversion. Specifically, the transformer converts the DC voltage from the battery to a usable DC voltage for the LEDs.

In one embodiment, the light component further includes a plurality of LEDs positioned on the exterior of the body component, wherein the LEDs provide illumination on the exterior surface in order to allow a user to be more easily seen in low-light conditions. Preferably, the device comprises at least one light emitting diode (LED), however, other fluorescent or incandescent lighting systems are contemplated. The plurality of LEDs can be situated around the perimeter or any location within the exterior surface of the backpack device in order to provide sufficient illumination for a user.

In one embodiment, the light component may be of a type comprising an LED, an incandescent, or a fluorescent, but is preferably a plurality of LEDs. In one embodiment, the plurality of LEDs are secured to a printed circuit board (PCB) via any suitable means as is known in the art. The PCB can be any suitable shape and size as is known in the art, with any number of LEDs attached. The PCB is then secured to the exterior surface of the backpack via adhesives, gluing, sewing, at least one nylon hook and loop strip, which enables the PCB to be temporarily installed and removed from the backpack device, as needed.

In one embodiment, the power pack component comprises a control switch which manually controls the plurality of LEDs. The control switch is located on the PCB of the LEDs and offers a means for a user to turn on or off the LEDs. In one embodiment, the power pack component is contained in a pocket attached to the interior of the front or back panel or is directly secured to the interior of the front or back panel. The control switch can then be secured to the interior or exterior along with the power pack component or independently, depending on the needs and/or wants of a user.

In one embodiment, the power pack component comprises a receiver. The receiver is used to communicate with a remote control, which then communicates with the microprocessor to control the color and pulse of the LEDs. Specifically, the remote control can alter the colors and pulse frequency of the LEDs. Typically, the plurality of LEDs are controlled with a Bluetooth remote control and can change colors and the pulse of the LEDs, depending on the needs and/or wants of a user. Further, multiple selections can be made to adjust the LEDs and customize their illumination patterns, colors, and frequency via the remote control. Any suitable remote control can be used as is known in the art.

In one embodiment, the light up backpack device further includes a wireless communications module and additional sensors which would allow the device to pair with a mobile application on a smart device. Once paired, a user could control the light up backpack device via the mobile application instead of a remote control.

In one embodiment, the power pack component comprises a light sensor. The plurality of LEDs communicate with the light sensor to turn off the LEDs when ambient light is detected. It shall be noted that the term ambient light is being used to describe light that is provided by the outside environment and may be artificial or naturally produced. Further, the light sensor will only turn off the LEDs after a predetermined period of time of ambient light is detected. For example, the predetermined amount of time may be 30 seconds of ambient light that is required before the light sensor turns off the LEDs. Furthermore, after a predetermined amount of time has elapsed where there is no more ambient light, the light sensor can turn the LEDs back on provided that the control switch is turned to the “ON” position. Thus, the light sensor ensures that the powering means (i.e., battery) are used efficiently.

In one embodiment, the power pack component comprises a motion sensor that is an impact sensor for detecting impact motion, such as occurs when walking. In a preferred embodiment, the controller determines a rate of motion detected by the motion sensor and sets a corresponding activation pattern, wherein the controller deactivates the LEDs after a predetermined period of time of detecting substantially no motion. Upon detection, the motion sensor transmits a signal to the microprocessor to activate the LEDs. The motion sensor also detects when the user stops moving, thereby deactivating the LEDs. The motion sensor may rely on any means, including microwave energy, ultrasonic waves, or radio frequency signals, to detect the motion of a user with the backpack device, however, infrared means are preferred.

In the preferred embodiment, the motion sensor is a passive infrared radiation detector (PIR). The motion sensor is sensitive to changes in radiation from within a close range. The user within the range emits infrared radiation of sufficient magnitude to trigger the motion sensor to provide an output signal. It is preferable, that the range of the motion sensor is narrowly focused to avoid detecting extraneous movements. Too large of a range will unnecessarily activate the lighting assembly, while too small of a coverage area will not activate the lighting assembly when required.

In one embodiment, the controller detects motion of the backpack via the motion sensor, the controller activates the LEDs with a corresponding rate of activation. As the rate of motion of the user will vary as the user increases and decreases motion, the rate of activation of the LEDs will vary. A variable illumination of the LEDS will increase the likelihood of the user and backpack device being noticed by other people.

In one embodiment, highly reflective material may surround opposing sides of the LEDs. It shall be noted that the use and amount of highly reflective material is important in that the more, the better.

In one embodiment, a schematic diagram of the light component and power pack component of the backpack device is shown. The light component includes at least one LED that employs at least three different color diodes in one casing; traditionally, these are red (R), green (G), and blue (B). The different colored diodes can be combined in different proportions to produce thousands of resultant colors when viewed by the human eye. In some embodiments, the LED includes fiber optic filaments attached thereto to allow the light illuminated from the LED to travel through the filament and glow at the other end.

The power pack component comprises a microprocessor, and a power supply in addition to at least one LED. In certain embodiments, at least one LED is formed into one or more arrays of LEDs, wherein each array that emits the same color have their cathode and anodes electrically tied together to form a channel. The channel is controlled by the microprocessor independently of the other channels. It is possible that some arrays may have a higher or lower total number of LEDs than others. It is also possible to have an array with only one LED that forms a channel.

Preferably, the power pack component includes one microprocessor to control the illumination and color of the LEDs, however, some embodiments may have multiple microprocessors controlling multiple sets of LEDs and their respective arrays. In operation, the user selects the desired resultant light color (i.e., white, purple, green) for the desired LED via a control switch. Preferably, the control switch is a sliding switch or a touch wheel switch, however, as readily recognized by those of ordinary skill in the art, a variety of control switches are appropriate, and these alterations and modifications are likewise contemplated. In addition, the control switch is configured to manually activate and deactivate the light component. The control switch is positioned on the power pack component and placed on a bottom surface of the interior volume of the backpack device, however, it is likewise contemplated that other suitable locations of the control switch are likewise contemplated, such as directly on a PCB. After the user selects the desired resultant color, the control switch relays the desired resultant color to the microprocessor.

The microprocessor controls the relative intensity level of each LED to achieve the desired resultant color. The intensity level of the LED is controlled using a pulse-width modulation (PWM) algorithm of a fixed current source provided by the power supply, preferably a battery. The microprocessor is able to control the different colored diodes within the LED by varying and modulating the current and relative intensity level to one another that flows through the different colored diodes that are encased within the LED. In the preferred embodiment, this is done by the PWM algorithm within the microprocessor, which adjusts the PWM for each LED to achieve the desired resultant color.

The PWM algorithm allows linear control of the intensity level of the different colored diodes in the LEDs; that is, the intensity level of the different colored diodes in the LED is directly proportional to the width of the pulse. The PWM algorithm uses pre-stored calibration data to determine the PWM that should be applied to achieve the desired resultant color. By varying the PWM of the different colored diodes of the LED, it is possible to generate thousands of different resultant colors. Although a microprocessor using a PWM algorithm is disclosed, this does not imply that there are no other means of accomplishing voltage and current control. These means are readily apparent to those of ordinary skill within this art and are all deemed within the spirit and scope of the present invention.

In yet another embodiment, the light up backpack device comprises a plurality of indicia.

In yet another embodiment, a method of illuminating a backpack to maintain safety for a user is disclosed. The method includes the steps of providing a light up backpack device comprising a body component and a plurality of LEDs secured to an exterior surface. The method also comprises powering the plurality of LEDs. The method comprises turning on the plurality of LEDs for use. Further, the method comprises controlling the plurality of LEDs via a remote control to change colors and/or pulse the LEDs. Finally, the method comprises wearing the illuminated backpack to maintain safety for the user.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the light up backpack device of the present invention showing the plurality of LEDs lit up on the device in accordance with the disclosed architecture;

FIGS. 2A-B illustrate a perspective view of one embodiment of the light up backpack device of the present invention showing the backpack device in accordance with the disclosed architecture;

FIGS. 3A-B illustrate a perspective view of one embodiment of the light up backpack device of the present invention showing a child wearing the device in accordance with the disclosed architecture;

FIG. 4 illustrates a perspective view of one embodiment of the light up backpack device of the present invention showing how the device illuminates a child in low-light, as a school bus approaches in accordance with the disclosed architecture;

FIGS. 5A-B illustrate a perspective view of one embodiment of the light up backpack device of the present invention showing the LEDs controlled by a remote control in accordance with the disclosed architecture;

FIG. 6 illustrates a block diagram of the wireless communication module in communication with a smart device and the light up backpack device of the present invention in accordance with the disclosed architecture;

FIG. 7 illustrates a schematic diagram of the light component and power pack component of the light up backpack device of the present invention in accordance with the disclosed architecture; and

FIG. 8 illustrates a flowchart showing the method of illuminating a backpack to maintain safety for a user in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a light up backpack device that provides users with a backpack featuring multiple exterior LED lights for easily identifying the user. There is also a long-felt need in the art for a light up backpack device that allows children to wear the backpack and maintain safety when waiting for a school bus near the side of the road during early morning or evening hours. Further, there is a long-felt need in the art for a light up backpack device that brightly illuminates in one or several colors to improve visibility of the user while adding a fun and unique flair to the backpack. Moreover, there is a long-felt need in the art for a device that includes a remote control that can alter the colors and pulse frequency of the lights. Further, there is a long-felt need in the art for a light up backpack device that comprises multiple selections that can be made to adjust the lights and customize their illumination patterns, colors, and frequency. Finally, there is a long-felt need in the art for a light up backpack device that can be used by hikers or motorcycle riders, as well.

The present invention, in one exemplary embodiment, is a novel light up backpack device. The light up backpack device comprises a body component that is configured in a conventional backpack shape with a plurality of LEDs secured to an exterior surface. The plurality of LEDs are controlled with a Bluetooth remote control and can change colors and the pulse of the LEDs. The light up backpack device helps keep the user safe by illuminating them on the side of the road when waiting for a school bus or other ride. The device may also be made for others to improve their safety, such as hikers and motorcyclists, etc. The present invention also includes a novel method of illuminating a backpack to maintain safety for a user. The method includes the steps of providing a light up backpack device comprising a body component and a plurality of LEDs secured to an exterior surface. The method also comprises powering the plurality of LEDs. The method comprises turning on the plurality of LEDs for use. Further, the method comprises controlling the plurality of LEDs via a remote control to change colors and/or pulse the LEDs. Finally, the method comprises wearing the illuminated backpack to maintain safety for the user.

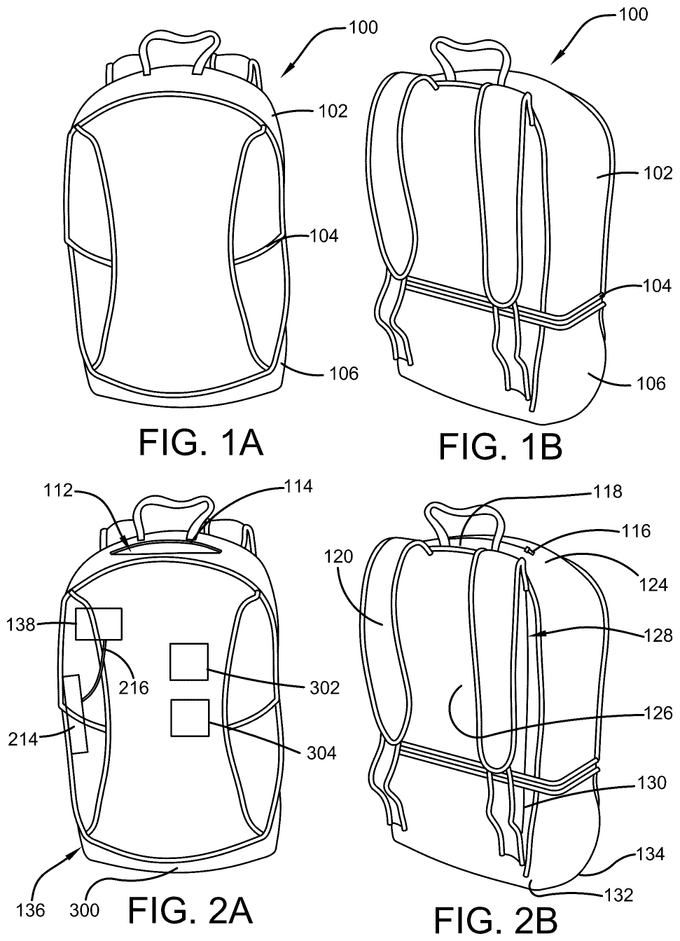

Referring initially to the drawings, FIGS. 1-2 illustrate a perspective view of one embodiment of the light up backpack device 100 of the present invention. In the present embodiment, the light up backpack device 100 is an improved light up backpack device 100 that provides a means for illuminating a backpack to maintain safety for a user. Specifically, the light up backpack device 100 comprises a body component 102 that is configured in a conventional backpack shape with a plurality of LEDs 104 secured to an exterior surface 106 of the body component 102. The light up backpack device 100 helps keep the user 108 safe by illuminating them on the side of the road when waiting for a school bus 110 or other rides. The device 100 may also be made for others to improve their safety, such as hikers and motorcyclists, etc., or any other suitable user as is known in the art.

Generally, the light up backpack device 100 comprises a body component 102 configured as a conventional backpack. Specifically, the body component 102 forms an interior volume 112 therein. The body component 102 includes an opening 114 that provides access to the interior volume 112, wherein the opening 114 includes a fastener 116 that selectively opens and closes access to the interior volume 112. Preferably, the fastener 116 is a zipper fastener, however, other suitable types of fasteners are contemplated. Preferably the body component 102 is substantially rectangular in shape with a central apex 118, however, it is contemplated that the shape of the body component 102 includes a variety of other shapes and forms. The body component 102 further includes at least one strap 120 attached thereon configured to be wrapped around a user's shoulder 122 to support the backpack device 100. It is likewise contemplated that the straps 120 can include a variety of other suitable types of straps 120 such as long shoulder straps or cross body straps. Alternative embodiments also may include a second shoulder strap 120 that allows a user 108 to wear the backpack device 100 around both shoulders 122.

In one embodiment, the body component 102 is adapted to conveniently carry various personal effects in three separate partitioned compartments each accessible by a zippered fastener 116. Further, at the top 124 of a back panel 126 are fastened top ends 128 of a pair of padded shoulder straps 120, the bottom ends 130 of which are connected to adjusting straps 132 fastened in turn to the bottom panel 134. Additionally, the backpack device 100 is hand or machine-washable.

Furthermore, the light up backpack device 100 comprises a light component 136 and a power pack component 138. The light component 136 typically comprises a plurality of LEDs 104 which are in communication with the power pack component 138. The power pack component 138 comprises a microprocessor 200 (or controller), at least one power source 202, a control switch 204, a transformer 206, a receiver 208, and at least one sensor 210, all for powering and controlling the LEDs 104. Further, at least one power source 202 is typically a battery 212 contained within a battery enclosure. In one embodiment, the battery 212 is rechargeable. Then at least one battery 212 provides the electricity needed to power the LEDs 104. Further, the power pack component 138, along with the battery 212, can be positioned inside the backpack device 100 and communicates with the PCB 214 (i.e., the plurality of LEDs 104) via wires 216 or other connecting means, as is known in the art.

The battery 212 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the light up backpack device 100. Throughout this specification, the term “battery” may be used interchangeably to refer to one or more wet or dry cells or batteries of cells in which chemical energy is converted into electricity and used as a source of DC power. References to recharging or replacing the battery 212 may refer to recharging or replacing individual cells, individual batteries of cells, or a package of multiple battery cells as is appropriate for any given battery technology that may be used. In addition, a rechargeable embodiment of the battery 212 may be recharged using a USB port (not shown), wherein the USB port is a USB-A, USB-B, Micro-B, Micro-USB, Mini-USB, or USB-C port, etc.

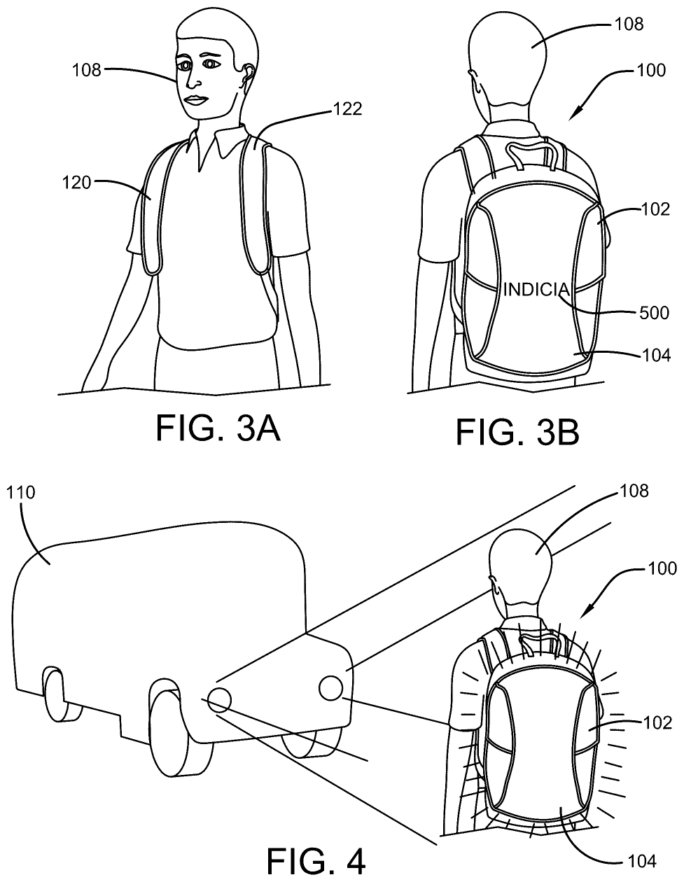

As shown in FIGS. 3-4, the power pack component 138 comprises a transformer 206 for voltage conversion. Specifically, the transformer 206 converts the DC voltage from the battery 212 to a usable DC voltage for the LEDs 104.

Furthermore, the light component 136 further includes a plurality of LEDs 104 positioned on the exterior 106 of the body component 102, wherein the LEDs 104 provides illumination on the exterior surface 106 in order to allow a user 108 to be more easily seen in low-light conditions. Preferably, the device 100 comprises at least one light emitting diode (LED) 104, however, other fluorescent or incandescent lighting systems are contemplated. The plurality of LEDs 104 can be situated around the perimeter 300 or any location within the exterior surface 106 of the backpack device 100 in order to provide sufficient illumination for a user 108.

Additionally, the light component 136 may be of a type comprising an LED 104, an incandescent, or a fluorescent, but is preferably a plurality of LEDs 104. In one embodiment, the plurality of LEDs 104 are secured to a printed circuit board (PCB) 214 via any suitable means as is known in the art. The PCB 214 can be any suitable shape and size as is known in the art, with any number of LEDs 104 attached. The PCB 214 is then secured to the exterior surface 106 of the backpack device 100 via adhesives, gluing, sewing, at least one nylon hook and loop strip, which enables the PCB 214 to be temporarily installed and removed from the backpack device 100, as needed.

Further, the power pack component 138 comprises a control switch 204 which manually controls the plurality of LEDs 104. The control switch 204 is located on the PCB 214 of the LEDs 104 and offers a means for a user 108 to turn on or off the LEDs 104. In one embodiment, the power pack component 138 is contained in a pocket attached to the interior of the front or back panel 126 or is directly secured to the interior of the front or back panel 126. The control switch 204 can then be secured to the interior or exterior along with the power pack component 138 or independently, depending on the needs and/or wants of a user 108.

In one embodiment, the power pack component 138 comprises a light sensor 302. The plurality of LEDs 104 communicate with the light sensor 302 to turn off the LEDs 104 when ambient light is detected. It shall be noted that the term ambient light is being used to describe light that is provided by the outside environment and may be artificial or naturally produced. Further, the light sensor 302 will only turn off the LEDs 104 after a predetermined period of time of ambient light is detected. For example, the predetermined amount of time may be 30 seconds of ambient light that is required before the light sensor 302 turns off the LEDs 104. Furthermore, after a predetermined amount of time has elapsed where there is no more ambient light, the light sensor 302 can turn the LEDs 104 back on provided that the control switch 204 is turned to the “ON” position. Thus, the light sensor 302 ensures that the powering means (i.e., battery 212) are used efficiently.

In another embodiment, the power pack component 138 comprises a motion sensor 304 that is an impact sensor for detecting impact motion, such as occurs when walking. In a preferred embodiment, the controller (microprocessor 200) determines a rate of motion detected by the motion sensor 304 and sets a corresponding activation pattern, wherein the controller 200 deactivates the LEDs 104 after a predetermined period of time of detecting substantially no motion. Upon detection, the motion sensor 304 transmits a signal to the microprocessor 200 to activate the LEDs 104. The motion sensor 304 also detects when the user 108 stops moving, thereby deactivating the LEDs 104. The motion sensor 304 may rely on any means, including microwave energy, ultrasonic waves, or radio frequency signals, to detect the motion of a user 108 with the backpack device 100, however, infrared means are preferred.

In the preferred embodiment, the motion sensor 304 is a passive infrared radiation detector (PIR). The motion sensor 304 is sensitive to changes in radiation from within a close range. The user 108 within the range emits infrared radiation of sufficient magnitude to trigger the motion sensor 304 to provide an output signal. It is preferable, that the range of the motion sensor 304 is narrowly focused to avoid detecting extraneous movements. Too large of a range will unnecessarily activate the lighting assembly, while too small of a coverage area will not activate the light component 136 when required.

In yet another embodiment, the controller 200 detects motion of the backpack device 100 via the motion sensor 304, the controller 200 activates the LEDs 104 with a corresponding rate of activation. As the rate of motion of the user 108 will vary as the user 108 increases and decreases motion, the rate of activation of the LEDs 104 will vary. A variable illumination of the LEDS 104 will increase the likelihood of the user 108 and backpack device 100 being noticed by other people.

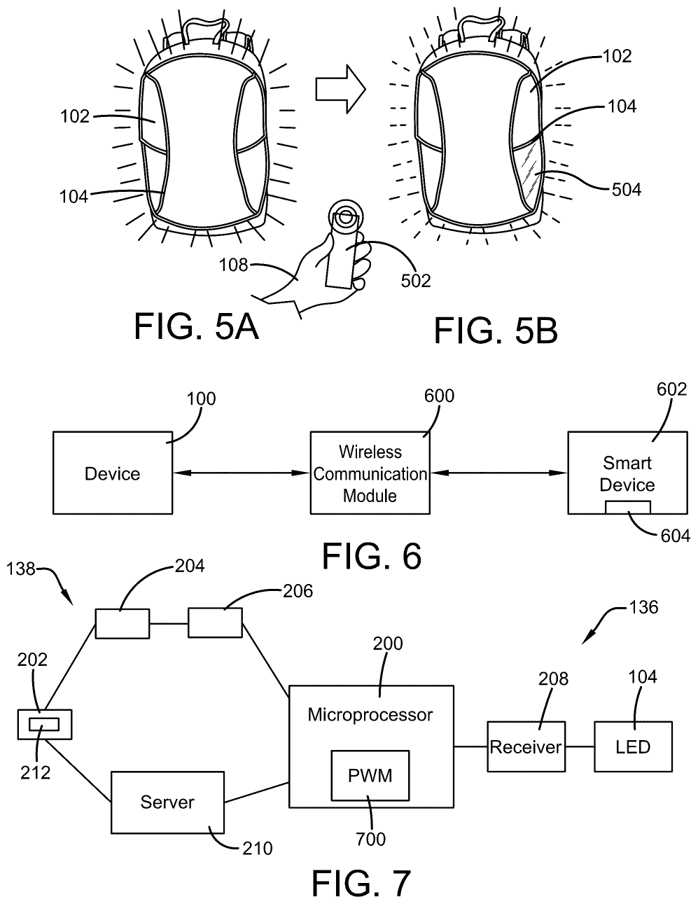

As shown in FIG. 5, the power pack component 138 comprises a receiver 208. The receiver 208 is used to communicate with a remote control 502, which then communicates with the microprocessor 200 to control the color and pulse of the LEDs 104. Specifically, the remote control 502 can alter the colors and pulse frequency of the LEDs 104. Typically, the plurality of LEDs 104 are controlled with a Bluetooth remote control 502 and can change colors and the pulse of the LEDs 104, depending on the needs and/or wants of a user 108. Further, multiple selections can be made to adjust the LEDs 104 and customize their illumination patterns, colors, and frequency via the remote control 502. Any suitable remote control 502 can be used as is known in the art.

In one embodiment, highly reflective material 504 may surround opposing sides of the LEDs 104. It shall be noted that the use and amount of highly reflective material 504 is important in that the more, the better.

In yet another embodiment, the light up backpack device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be backpack, illumination, or brand related.

FIG. 6 illustrates a block diagram of the wireless communication module 600 in communication with a smart device 604 and the light up backpack device 100 of the present invention. The light up backpack device 100 further includes a wireless communications module 600 and additional sensors which would allow the device 100 to pair with a mobile application 602 on a smart device 604. Once paired, a user 108 could control the light up backpack device 100 via the mobile application 602 instead of a remote control 502.

As shown in FIG. 6, the mobile device or smart device 604 may be a cellular telephone, a remote control, or any other device that may have wireless communication capabilities and may be connected to the internet. The mobile or smart device 604 may perform any type of wireless communication, including, but not limited to, WIFI, BLUETOOTH, RFID, NFC, etc. Thus, the device 100 further includes a wireless communication module 600 and additional sensors which would allow the device 100 to pair with a mobile application 602 on a mobile or smart device 604 to control the colors and pulse frequency of the LEDs 104, as well as powering the device 100 on/off.

As shown in FIG. 7, a schematic diagram of the light component 136 and power pack component 138 of the backpack device 100 is shown. The light component 136 includes at least one LED 104 that employs at least three different color diodes in one casing; traditionally, these are red (R), green (G), and blue (B). The different colored diodes can be combined in different proportions to produce thousands of resultant colors when viewed by the human eye. In some embodiments, the LED 104 includes fiber optic filaments attached thereto to allow the light illuminated from the LED 104 to travel through the filament and glow at the other end.

The power pack component 138 comprises a microprocessor 200, a power supply 202 in addition to at least one LED 104. In certain embodiments, at least one LED 104 is formed into one or more arrays of LEDs 104, wherein each array that emits the same color have their cathode and anodes electrically tied together to form a channel. The channel is controlled by the microprocessor 200 independently of the other channels. It is possible that some arrays may have a higher or lower total number of LEDs 104 than others. It is also possible to have an array with only one LED 104 that forms a channel.

Preferably, the power pack component 138 includes one microprocessor 200 to control the illumination and color of the LEDs 104, however, some embodiments may have multiple microprocessors 200 controlling multiple sets of LEDs 104 and their respective arrays. In operation, the user 108 selects the desired resultant light color (i.e., white, purple, green) for the desired LED 104 via a control switch 204. Preferably, the control switch 204 is a sliding switch or a touch wheel switch, however, as readily recognized by those of ordinary skill in the art, a variety of control switches 204 are appropriate, and these alterations and modifications are likewise contemplated. In addition, the control switch 204 is configured to manually activate and deactivate the light component 136. The control switch 204 is positioned on the power pack component 138 and placed on a bottom surface of the interior volume 112 of the backpack device 100, however, it is likewise contemplated that other suitable locations of the control switch 204 are likewise contemplated, such as directly on the PCB 214. After the user 108 selects the desired resultant color, the control switch 204 relays the desired resultant color to the microprocessor 200.

The microprocessor 200 controls the relative intensity level of each LED 104 to achieve the desired resultant color. The intensity level of the LED 104 is controlled using a pulse-width modulation (PWM) algorithm 700 of a fixed current source provided by the power supply 202, preferably a battery 212. The microprocessor 200 is able to control the different colored diodes within the LED 104 by varying and modulating the current and relative intensity level to one another that flows through the different colored diodes that are encased within the LED 104. In the preferred embodiment, this is done by the PWM algorithm 700 within the microprocessor 200, which adjusts the PWM 700 for each LED 104 to achieve the desired resultant color.

The PWM algorithm 700 allows linear control of the intensity level of the different colored diodes in the LEDs 104; that is, the intensity level of the different colored diodes in the LED 104 is directly proportional to the width of the pulse. The PWM algorithm 700 uses pre-stored calibration data to determine the PWM 700 that should be applied to achieve the desired resultant color. By varying the PWM 700 of the different colored diodes of the LED 104, it is possible to generate thousands of different resultant colors. Although a microprocessor 200 using a PWM algorithm 700 is disclosed, this does not imply that there are no other means of accomplishing voltage and current control. These means are readily apparent to those of ordinary skill within this art and are all deemed within the spirit and scope of the present invention.

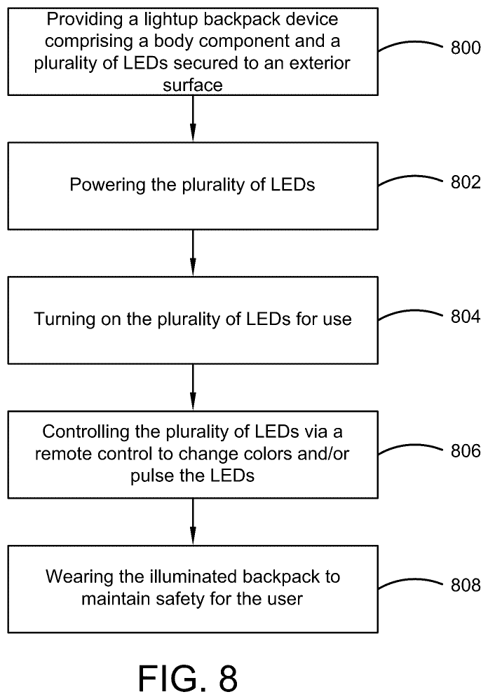

FIG. 8 illustrates a flowchart of the method of illuminating a backpack to maintain safety for a user. The method includes the steps of at 800, providing a light up backpack device comprising a body component and a plurality of LEDs secured to an exterior surface. The method also comprises at 802, powering the plurality of LEDs. The method comprises at 804, turning on the plurality of LEDs for use. Further, the method comprises at 806, controlling the plurality of LEDs via a remote control to change colors and/or pulse the LEDs. Finally, the method comprises at 808, wearing the illuminated backpack to maintain safety for the user.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “light up backpack device”, “light up device”, “backpack device”, and “device” are interchangeable and refer to the light up backpack device 100 of the present invention.

Notwithstanding the foregoing, the light up backpack device 100 of the present invention can be of any suitable size and configuration as is known in the art without affecting the overall concept of the invention, provided that it accomplishes the above-stated objectives. One of ordinary skill in the art will appreciate that the light up backpack device 100 as shown in FIGS. 1-8 is for illustrative purposes only, and that many other sizes and shapes of the light up backpack device 100 are well within the scope of the present disclosure. Although the dimensions of the light up backpack device 100 are important design parameters for user convenience, the light up backpack device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A light up backpack device that provides a user with an illuminating backpack to maintain safety for a user, the light up backpack device comprising:
a body component configured as a conventional backpack shape; and
a light component;
wherein the light component is secured to an exterior surface of the body component;
wherein the light component is powered by a power source secured within the body component and in communication with the light component via at least one wire; and
further wherein the light component illuminates an exterior of the body component to keep a user safe when in low-light conditions.

2. The light up backpack device of claim 1, wherein the body component forms an interior volume and includes an opening that provides access to the interior volume, and wherein the opening includes a fastener.

3. The light up backpack device of claim 2, wherein the body component is substantially rectangular in shape with a central apex, and a top of a back panel are fastened top ends of a pair of padded shoulder straps, bottom ends of which are connected to adjusting straps fastened in turn to a bottom panel.

4. The light up backpack device of claim 3, wherein the light component comprises a plurality of LEDs which are in communication with a power pack component.

5. The light up backpack device of claim 4, wherein the power pack component comprises a microprocessor, at least one power source, a control switch, a transformer, a receiver, and at least one sensor, all for powering and controlling the plurality of LEDs.

6. The light up backpack device of claim 5, wherein at least one power source is a battery.

7. The light up backpack device of claim 6, wherein the transformer converts DC voltage from the battery to a usable DC voltage for the plurality of LEDs.

8. The light up backpack device of claim 7, wherein the plurality of LEDs are secured to a printed circuit board (PCB).

9. The light up backpack device of claim 8, wherein the control switch manually controls the plurality of LEDs off/on.

10. The light up backpack device of claim 9, wherein the power pack component comprises a light sensor that communicates with the plurality of LEDs to turn off/on the LEDs when ambient light is detected/not detected for a predetermined period of time.

11. The light up backpack device of claim 10, wherein the power pack component comprises a motion sensor that is an impact sensor for detecting impact motion, such as walking, wherein the motion sensor communicates with the plurality of LEDs to turn off/on the LEDs after a predetermined period of time of detecting substantially no motion/motion.

12. The light up backpack device of claim 11, wherein the power pack component comprises a receiver used to communicate with a remote control, which then communicates with the microprocessor to control color and pulse of the plurality of LEDs.

13. A light up backpack device that provides a user with an illuminating backpack to maintain safety for a user, the light up backpack device comprising:
a body component configured as a conventional backpack shape;
a light component comprises a plurality of LEDs which are in communication with a power pack component; and
a power pack component comprising a microprocessor, at least one power source, a control switch, a transformer, a receiver, and at least one sensor, all for powering and controlling the plurality of LEDs;
wherein the light component is secured to an exterior surface of the body component;
wherein the light component is powered by a power source secured within the body component and in communication with the light component via at least one wire;
wherein the light component illuminates an exterior of the body component to keep a user safe when in low-light conditions;
wherein at least one power source is a battery;
wherein the transformer converts DC voltage from the battery to a usable DC voltage for the plurality of LEDs;
wherein the plurality of LEDs are secured to a printed circuit board (PCB);
wherein the control switch manually controls the plurality of LEDs off/on;
wherein the power pack component comprises a light sensor that communicates with the plurality of LEDs to turn off/on the LEDs when ambient light is detected/not detected for a predetermined period of time;
wherein the power pack component comprises a motion sensor that is an impact sensor for detecting impact motion, such as walking, wherein the motion sensor communicates with the plurality of LEDs to turn off/on the LEDs after a predetermined period of time of detecting substantially no motion/motion; and
further wherein the power pack component comprises a receiver used to communicate with a remote control, which then communicates with the microprocessor to control color and pulse of the plurality of LEDs.

14. The light up backpack device of claim 13 further comprising highly reflective material surrounding opposing sides of the plurality of LEDs.

15. The light up backpack device of claim 13 further comprising a plurality of indicia.

16. The light up backpack device of claim 13, wherein further comprising a wireless communications module which pairs with a mobile application on a smart device to control the light up backpack device instead of a remote control.

17. The light up backpack device of claim 13, wherein the motion sensor activates the plurality of LEDs with a corresponding rate of activation, per rate of motion of the user.

18. The light up backpack device of claim 13, wherein the control switch is positioned on the power pack component and placed on a bottom surface of an interior volume of the light up backpack device.

19. The light up backpack device of claim 13, wherein intensity level of the plurality of LEDs is controlled using a pulse-width modulation (PWM) algorithm of a fixed current source provided by the battery, such that the PWM algorithm within the microprocessor adjusts the PWM algorithm for each LED to achieve desired resultant color.

20. A method of illuminating a backpack to maintain safety for a user, the method comprising the following steps:
providing a light up backpack device comprising a body component and a plurality of LEDs secured to an exterior surface;
powering the plurality of LEDs;
turning on the plurality of LEDs for use;
controlling the plurality of LEDs via a remote control to change colors and/or pulse the LEDs; and
wearing the illuminated backpack to maintain safety for the user.
